(19) United States
(12) Patent Application Publication
(10) Pub. No.: US 2013/0090951 A1
(43) Pub. Date: Apr. 11, 2013

(54) SYSTEM AND METHOD FOR PREMIUM FINANCING

(71) Applicants: Kevin Carias, Newport Beach, CA (US); Malcolm McKee, Newport Beach, CA (US); Rober Eakin, Newport Beach, CA (US)

(72) Inventors: Kevin Carias, Newport Beach, CA (US); Malcolm McKee, Newport Beach, CA (US); Rober Eakin, Newport Beach, CA (US)

(21) Appl. No.: 13/269,458

(22) Filed: Oct. 7, 2011

(51) Int. Cl. G06Q 40/08

(52) U.S. Cl. 705/4

(57) ABSTRACT

The present invention is a system and method for financing insurance policy premiums on behalf of an insured via a premium financing loan. The present invention creates a plurality of contractual relationships of premium financing transactions and a computer-method of monitoring thereof between the insurance policy provider, insured, and premium finance company. The present invention provides a premium financing system and method that promotes long-term and permanent policies at origination, reduces the cost of insurance and/or policy loads, maximize the policyholder's cash surrender value, eliminates restrictive industry net worth and credit, increases business for agencies and carriers, creates a virtually unlimited capital, transfers interest rate risk from the insured to the fixed income investor, and provides a longer in-force holding period, thereby resulting in larger profits for the premium finance company and insurance carrier.

### FIELD OF THE INVENTION

The present invention relates to premium financing plans. Specifically, the present invention relates to a system and method for funding and/or financing insurance policy premiums through contractual relationships among an insurance policy provider, the insured, and a premium finance company.

### BACKGROUND OF THE INVENTION

For decades, life insurance has been an important component of financial planning for many individuals. The insurer promises to pay a designated beneficiary a certain amount of money upon the death (or other events, depending upon the term of the contract) of the insured, and in return, the policyholder agrees to pay a stipulated amount (i.e., “premiums”) at regular intervals or in lump sums. Through this agreement, the policy owner acquires a peace of mind in knowing that the death of the insured person will not result in financial hardship for the beneficiary of the insurance policy.

Paying the premium for life insurance, however, typically requires significant payments, especially for those individuals who have a high net worth. To cover the cost of an insurance premium, a third party finance entity, such as a financing company, may occasionally provide financing for the premiums. Under current premium financing models, the individual requesting insurance must sign a premium finance agreement with the premium finance company. The premium finance company then pays the insurance premiums with a loan (i.e., premium finance loan) and bills or invoices the individual insured, or the policyholder, for fees and costs of the loan, which is usually made in monthly installments. Currently, premium financing is a preferred way for affluent people, who do not wish to liquidate their other assets, to pay for life insurance premiums.

Notwithstanding the benefits of premium financing as currently modeled, current premium financing models are not be suited for every individual in all regions. Many current premium financing models, for instance, promote short-term and speculative policy origination, which often leads to early surrenders or early life settlement transactions. These surrenders, in turn, often drive up the cost of insurance for existing and future policyholders. Additionally, the restrictive industry net worth and credit standards exclude many policyholders from obtaining premium financing, which decreases business for agencies and insurance carriers. Furthermore, limited capital creates tight credit markets, thereby leading to a large demand gap relative to a number of policyholders who seek premium financing options rather than the availability of capital. The insured may also assume a risky interest rate in a period of high probability of escalating borrowing rates.

In light of the foregoing, there is a need for a premium financing system and method that promotes long-term securitization of short-term premium financing loans. Specifically, what is needed is a premium financing system that, at least: (1) promotes long-term and permanent policies; (2) reduces the cost of insurance and/or policy loads; (3) maximizes the policyholder's cash surrender value; (4) eliminates restrictive industry net worth and credit requirements; (5) increases business for insurance agencies and carriers; (6) expand the premium finance capital markets; (7) transfers interest rate risk from the insured to the fixed income investor; and (8) provides a longer in-force holding period, resulting in larger profits for the premium finance company and insurance carrier.

### SUMMARY OF THE INVENTION

To minimize the limitations in the prior art, and to minimize other limitations that will become apparent upon reading and understanding the present specification, the present invention discloses a new and useful method for insurance premium financing.

One embodiment of the invention is method for financing insurance policy premiums, the steps comprising: obtaining a short-term capital; creating a prepaid structure with one or more carriers to finance an insurance policy of an insured; wherein the prepaid structure utilizes a premium finance loan; wherein the prepaid structure utilizes a premium payment account; wherein the premium payment account is used only to pay the one or more premiums of the insurance policy; funding an initial payment of one or more premiums of the insurance policy with the short-term capital; funding the premium payment account; paying the one or more premiums of the insurance policy by using the premium payment account; creating an asset; wherein the asset is derived from the prepaid structure; wherein the asset is subject to a guaranty by the one or more carriers; obtaining a collateral assignment from the insured; wherein the collateral assignment secures the funding of the initial payment of the one or more premiums; wherein the collateral assignment secures the funding of the premium payment account; selling the premium finance loan asset to a special purpose vehicle; transferring the collateral assignment, one or more policy cash values, and one or more balances of the premium payment account to the special purpose vehicle; issuing one or more securities by the special purpose vehicle; selling the one or more securities by the special purpose vehicle to replenish the short-term capital; imposing a fee to the insured for the premium finance loan; arranging a policy loan at a maturity of the one or more securities, such that a redemption of a security investment value exists; and maintaining the one or more policy cash values, such that the policy loan remains in effect. Preferably, the prepaid structure does not subject the insurance policy to an adverse tax treatment. Preferably, the prepaid structure utilizes a regular premium policy. The one or more premiums are generally subject to one or more discounts, and the one or more discounts are based upon a predetermined yield of the premium payment account. Typically, the asset has a predetermined minimum value and a maturity date. Preferably, the one or more securities are backed by the one or more policy cash values, and the one or more securities is typically backed by one or more premium finance loan interest payments. The premium finance loan interest payments are usually payable until maturity of the premium finance loan. The fee should be valued at a market-rate interest of the premium finance loan, and the market-rate interest should be amortized until maturity of the premium finance loan. Preferably, the method further comprises the step of recouping an unpaid portion of the fee by obtaining one or more cash-value disbursements at maturity of the premium finance loan. The method also should further comprise the step of recouping an unpaid portion of the fee by obtaining one or more proceeds from a policy death benefit arrangement.

Another embodiment of the present invention is a computer-based method for storing and monitoring information of premium financing, the steps comprising: inputting and storing a short-term capital data into an electronic data processing unit for an insurance policy; wherein the short-term capital data provides information of funding an initial payment of one or more premiums of the insurance policy of an insured; creating a prepaid structure for the insurance policy; inputting and storing prepaid structure data of the prepaid structure into the electronic data processing unit; wherein the prepaid structure data provides information of the prepaid structure; transferring funds to a premium payment account; wherein the premium payment account is used solely for paying one or more premiums of the insurance policy; inputting and storing premium payment account data into the electronic data processing unit; wherein the premium payment account data provides information of funding the premium payment account; creating a premium finance loan asset; wherein the premium finance loan asset includes a predetermined minimum value in the electronic data processing unit; determining a maturity date of the premium finance loan asset; securing a collateral assignment from the insured; inputting and storing collateral assignment data into the electronic data processing unit; wherein the collateral assignment data provides information of the collateral assignment; selling the premium finance loan asset to a special purpose vehicle; inputting and storing premium finance loan asset data into the electronic data processing unit; wherein the premium finance loan asset data provides information of the premium finance loan asset; transferring the collateral assignment and the premium payment account to the special purpose vehicle; issuing one or more securities by the special purpose vehicle; selling one or more securities by the special purpose vehicle; inputting securities data into the electronic data processing unit; wherein the securities data provides information of the one or more securities; imposing a fee to the insured for the premium finance loan; inputting and storing fee data to the electronic data processing unit; wherein the fee data provides information of the fee; arranging a policy loan at maturity of the one or more securities; inputting and storing the policy loan data into the electronic data processing unit; wherein the policy loan data provides information of the policy loan; maintaining the policy loan with sufficient funding, such that the policy loan remains in effect; and monitoring the policy loan data with the electronic data processing unit, such that the policy loan has sufficient funding. Preferably, the prepaid structure does not subject the insurance policy to an adverse tax treatment. Preferably, the prepaid structure utilizes a regular premium policy; and preferably includes a further step of inputting and storing regular premium policy data into the electronic data processing unit; wherein the premium policy data provides information of the regular premium policy. The one or more premiums should be subject to one or more discounts, and the method should have an additional step of inputting and storing discount data into the electronic data processing unit; wherein the discount data provides information of one or more discounts. Preferably, the one or more securities is backed by one or more premium finance loan interest payments. Preferably, the fee is valued at a market-rate interest of the premium finance loan; wherein the market-rate interest is amortized until maturity of the premium finance loan. The method should further include the steps of recouping of an unpaid portion of the fee by obtaining one or more proceeds from a policy death benefit arrangement; recouping an unpaid portion of the fee by obtaining one or more cash-value disbursements at the maturity of the premium finance loan; and inputting and storing one or more recouping data into the electronic data processing unit. The method may further comprise the steps of: monitoring the short-term capital data; monitoring the prepaid structure data; monitoring the premium payment account data; monitoring the collateral assignment data; monitoring the premium finance loan asset data; monitoring the securities data; monitoring the fee data; monitoring the policy loan data; monitoring the regular premium policy data; monitoring the discount data; and monitoring the one or more recouping data; wherein the monitoring steps are performed using the electronic data processing unit.

Another embodiment of the present invention is a method for financing insurance policy premiums, the steps comprising: obtaining a short-term capital; creating a prepaid structure to finance an insurance policy of an insured; wherein the prepaid structure utilizes a premium finance loan; wherein the prepaid structure does not subject the insurance policy to an adverse tax treatment; wherein the prepaid structure utilizes a premium payment account; wherein the prepaid structure is approved by one or more insurance policy providers; wherein the premium payment account is used solely for paying the one or more premiums of the insurance policy; wherein the prepaid structure utilizes a regular premium policy; funding the initial payment of one or more premiums of the insurance policy with the short-term capital; funding the premium payment account, such that the one or more premiums of the insurance policy are always paid; wherein the one or more premiums are subject to one or more discounts; wherein the one or more discounts are based upon a predetermined yield of the premium payment account; creating a premium finance loan asset; wherein the premium finance loan asset is derived from the prepaid structure; wherein the premium finance loan asset has a predetermined minimum value; wherein the premium finance loan asset has a maturity date; wherein the premium finance loan asset is subject to a guaranty by the one or more insurance policy providers; obtaining a collateral assignment from the insured; wherein the collateral assignment secures the funding of the initial payment of the one or more premiums; wherein the collateral assignment secures the funding of the premium payment account; selling the premium finance loan asset to a special purpose vehicle; transferring the collateral assignment to the special purpose vehicle; transferring one or more policy cash values to the special purpose vehicle; transferring one or more balances of the premium payment account to the special purpose vehicle; issuing one or more securities by the special purpose vehicle; wherein the one or more securities is backed by the one or more policy cash values; wherein the one or more securities is backed by one or more premium finance loan interest payments; wherein the premium finance loan interest payments are payable until maturity of a premium finance loan; selling the one or more securities by the special purpose vehicle to replenish the short-term capital; imposing a fee to the insured for the premium finance loan; wherein the fee is valued at a market-rate interest of the premium finance loan; wherein the market-rate interest is amortized until maturity of the premium finance loan; recouping an unpaid portion of the fee by obtaining one or more cash-value disbursements at the maturity of the premium finance loan; recouping an unpaid portion of the fee by obtaining one or more proceeds from a policy death benefit arrangement; arranging a policy loan at a maturity of the one or more securities, such that a redemption of a security investment value exists; and maintaining the one or more policy cash values, such that the policy loan remains in effect.

It is an object of the present invention to provide a method of facilitating premium financing for life insurance policy issued by an insurance policy provider and purchased by a policyholder.

It is an object of the present invention to provide a premium financing system and method that promotes long-term and permanent policies at origination.

It is an object of the present invention to provide a premium financing system and method that eliminates early surrenders, which reduce the cost of insurance and policy loads and maximizes the policyholder's cash surrender value (“CSV”).

It is an object of the present invention to provide a premium financing system and method that eliminates restrictive industry net worth and credit standards required for policyholders to obtain premium financing, thereby increasing business for agencies and carriers.

It is an object of the present invention to provide a premium financing system and method that creates a virtually unlimited capital pool. The high current and future premium financing demand can be met by a global fixed income market seeking “safe haven” investment products

It is an object of the present invention to provide a premium financing system and method that transfers the interest rate risk from the insured to the fixed income investor, which potentially leads to more insured customers.

It is an object of the present invention to provide a premium financing system and method that provides a longer in-force holding period, which results in greater profits for the agency and/or agent of the premium finance company and carrier.

It is an object of the present invention to create securities insurance products designed to provide: (1) high Comdex™ ratings (preferably 92+), which insures lower security price discounts; (2) a 10-pay structure that has maximum paid-up addition riders to provide the greatest possible cash surrender value accumulation during securitization term; (3) payments of the initial premium and future premiums, wherein the future payments are paid by funds deposited in a premium payment account; (4) a securitization term designed for a minimum of ten (10) years and a maximum of thirty (30) years; (5) a policy cash surrender value and premium payment account, which are assigned to a lender, transferred to the security issuer, and ultimately used as collateral for a security investor; and (6) policy loans used to redeem security investors, while leaving sufficient cash surrender value to provide permanent life coverage to the insured.

It is an object of the present invention to provide a zero coupon securities structure (i.e., non-coupon bearing). The securities issuer should receive from the premium finance company a collateral assignment of all participating policy cash surrender values, and if applicable, a portion of death benefit proceeds.

It is an object of the present invention to provide cash surrender values that have: (1) a guaranteed value—i.e., wherein the minimum value is at a future point in time guaranteed by the insurance policy provider and has a very low price discount; (2) a non-guaranteed value—i.e., the minimum value is at a future point in time not guaranteed by the insurance policy provider, but has a high probability of achieving based on historical dividend payouts by the insurance policy provider and a standard deviation of the next lowest risk price discount; and (3) an insurance policy provider-approved “split dollar” arrangement—i.e., a percentage of the insured's death benefit collateralized by and payable to the premium finance company for the reimbursement of any accrued financing charges, including expected yields for security investors.

It is an object of the present invention to provide the user with the necessary features of inputting and storing insurance policy content tailored to a premium financing company. Specifically, the present invention gathers important data information of the insured such as short-term capital data, prepaid structure data, premium payment account data, collateral assignment data, premium finance loan asset data, securities data, fee data, policy loan data, regular premium policy data, discount data, data for recouping premium finance loan interest, and any other relevant information for the premium financing method.

It is another object of the present invention to provide a premium financing system and method that: a) provides a one time, permanent financing structure, which is incorporated into the insured's premium finance loan and is designed for use in whole life, and to a lesser degree, indexed-universal life insurance products; b) provides an up-front payment by the premium finance company of all current and future premium(s) to the insurance policy provider on a discounted cash flow bases; c) provides a long-term, fixed amortization by the premium finance company of annual insured premium finance loan interest payable; d) provides the securitization of the premium finance loan into a variety of market-specific investment products (i.e., securities); e) provides a sale of premium finance loan asset-backed investment securities to investors at prevailing market prices; f) provides a variable redemption value and term structure; and g) provides a fixed minimum yield, with a variable upside yield to investor based on accumulated policy cash value, insured premium financing interest payable and, if appropriate, a split-dollar settlement of debt obligation(s) through the insured's estate upon payment of death benefit.

It is an object of the present invention to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a block diagram of one embodiment of the premium financing method and system, which shows the components and interrelations of the premium financing method.

FIG. 2 is a flow chart of one embodiment of the premium financing method and system.

FIG. 3 is a block diagram of one embodiment of an electronic data processing unit of the computer-based method for premium financing and shows the data components of the computer-based method.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, the term “electronic data processing unit” refers to any device that processes information with an integrated circuit chip, including without limitation, mainframe computers, work stations, servers, desktop computers, portable computers, laptop computers, embedded computers, digital clocks, wireless devices including cellular phones, tablet computers, personal digital assistants, and hand-held computers.

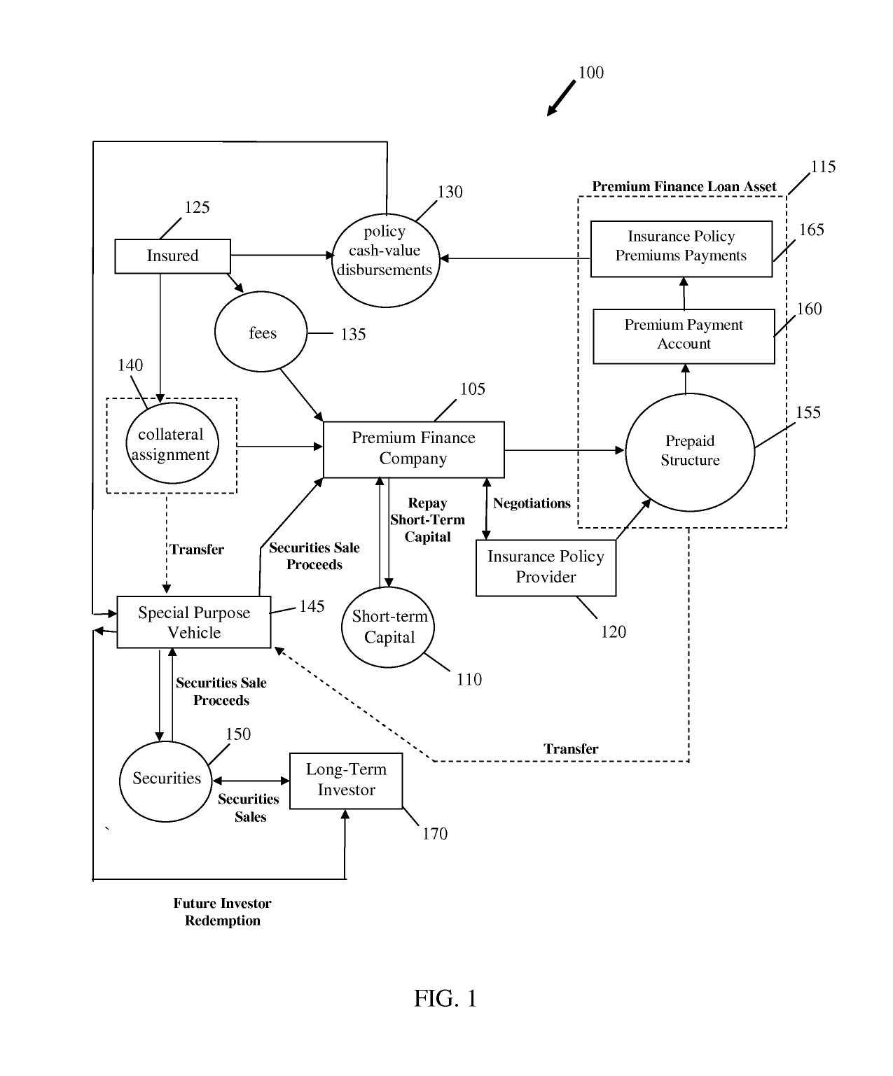

FIG. 1 is a block diagram of one embodiment of the premium financing method, which shows the components and interrelations of the premium financing method. As shown in FIG. 1, the premium finance method 100 preferably includes: a premium finance company 105; short-term capital 110; a premium finance loan asset 115; insurance policy provider 120; an insured 125; policy cash-value disbursements 130; fees 135; collateral assignment 140; special purpose vehicle 145; securities 150, and long-term investor 170. Also, the premium finance loan asset 115 preferably includes: a prepaid structure 155; premium payment account 160; and insurance policy premium payments 165. Generally, when there is a life insurance contract between the insurance policy provider 120 and insured 125, the insured 125 typically provides insurance policy premium payments 165 at regular intervals or lump sums. Because the payments for the premiums can be expensive, a premium finance company 105 can assist the insured 125 by providing premium finance loans to cover the cost of an insurance premium. As shown in FIG. 1, the premium finance company 105 provides a premium finance loan asset 115, which typically involves acquiring short-term capital 110. Preferably, the short-term capital 110 is the funds used to finance the initial premium of the insurance policy. The premium finance loan asset 115 is the value derived from the prepaid structure (by agreement) 155 made between the premium finance company 105 and insurance policy provider 120 (i.e., “carrier”), and also includes a premium payment account 160 and insurance policy premium payments 165. Additionally, the premium finance loan asset 115 would preferably have a predetermined minimum value and maturity date subject to a guaranty by the insurance policy provider 120. The premium payment account 160, which might be similar to a money-market or certificate of deposit (CD) account, is preferably used to provide payments to insurance policy premiums. The prepaid structure 155 is the business model in which the premiums of the insurance policy are paid over a certain period of time, and is preferably negotiated between the premium finance company 105 and insurance policy provider 120. Because a single premium policy is subject to Section 7702A of the Internal Revenue Code, the prepaid structure 155 is preferably not a single premium policy, but rather, a regular premium policy structure. A single premium insurance policy is the payment arrangement that permits an insurer to invest a lump sum to fully pay an insurance policy, whereas a regular premium policy is the payment arrangement, in which the insurers pay payments over a given period of time. Further, single premiums are preferably for individuals who prefer to commit a large sum of money, whereas regular premiums are for other individuals who have recurring or regular source of income.

FIG. 1 also shows a premium payment account 160, which is used by the premium financing company 105 to fund future payments of the insurance policy premiums. These payments may be discounted by the account yields of the premium payment account 160; wherein the discount of the prepaid structure 155 should be negotiated between the premium financing company 105 and the insurance policy provider 120.

FIG. 1 also shows a collateral assignment 140 made between the insured 125 and premium financing company 105. A collateral assignment 140 is an asset assignment, in which the ownership rights are transferred as an additional security or collateral for the premium finance loan Importantly, the ownership rights revert back to the assignor once the loan is repaid. Most often the collateral assignment 140 is used to guarantee repayment of the loan upon the death of debtor, and if the collateral assignment 140 is used against life insurance, the assignee (i.e., the premium financing company 105) will receive any amount due to them before the beneficiary is paid the remainder. As such, the collateral assignment 140 is preferably used to secure the short-term capital 110 and funds derived from the premium payment account 160.

FIG. 1 also shows a special purpose vehicle 145, which is a legal entity created to fulfill certain, specific objectives. Preferably, the special purpose vehicle 145 is used by the premium finance company 105 to acquire certain assets, such as the premium finance loan asset 115 and collateral assignment 140, which may also include all the current and future insurance policy cash value.

The special purpose vehicle 145 also performs other functions as well, such as issuing and selling securities 150. After securities 150 are issued, the securities 150 are sold to a long-term investor 150. The sales or proceeds of the securities are then transferred from the special purpose vehicle 145 to the premium finance company 105 in order to replenish the short-term capital. Preferably, the securities 150 represent the investments of whole life products, and may be registered or unregistered. Furthermore, securities 150 may be backed by guaranteed and non-guaranteed policy cash values, as well as a split of insured premium finance loan interest payments payable until maturity of the premium finance loan. Additionally, the securities 150 are preferably structured with a zero coupon structure (i.e., they are non-coupon bearing). Preferably, the special purpose vehicle 145 receives from the premium finance company a collateral assignment 140 of all participating policy cash surrender value, and if applicable, death benefits.

The insurance products being securitized preferably have high Comdex ratings (preferably 92+), which insures lower security price discounts and a 10-pay structure that has a maximum paid-up addition riders to provide the greatest possible cash surrender value accumulation during securitization term. Additionally, the securities should provide payments of the initial premium and future premiums; wherein the future payments are paid by funds deposited in a premium payment account. The securitization term should be designed for a minimum of ten years and a maximum of thirty years, and the a policy cash surrender value and premium payment account, which are assigned to a lender, are typically transferred to the security issuer, and ultimately used as collateral for the long-term investor 170. Furthermore, the securities should provide policy loans used to redeem security investors, while leaving sufficient cash surrender value to provide permanent life coverage to the insured.

FIG. 1 also shows fees 135, which are typically the interest (preferably market-rate interest) accrued from loans owed to the premium financing company for subsidizing the insurance policy premium payments 165. The market-rate interest 135 should be a fixed interest and may be amortized until maturity. In the event that the premium financing company 105 does not receive payment of the market-rate interest 135, the premium financing company 105 may obtain policy cash-value disbursements 130, which are payments to recoup any unpaid payments for the premium finance loan. The policy cash-value disbursements 130, which typically include the cash surrender value of the loan, may also be transferred from the special purpose vehicle 145 to the long term investor 170 for purposes of securities redemption.

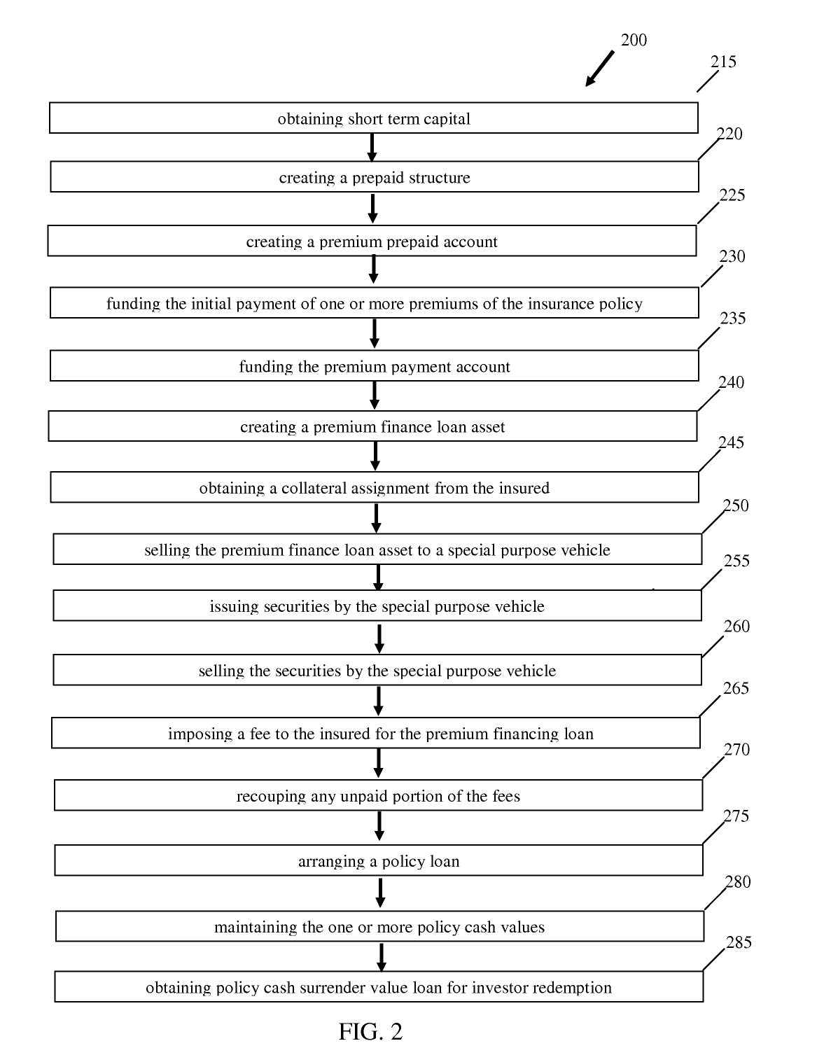

FIG. 2 is a flow chart of one embodiment of the premium financing method and system. As shown in FIG. 2, the premium financing method 200 preferably includes the steps of: obtaining short-term capital 215; creating a prepaid structure 220; creating a premium prepaid account 225; paying or funding the initial payment of one or more premiums of the insurance policy 230; funding a premium payment account 235; creating a premium finance loan asset 240; obtaining a collateral assignment from the insured 245; selling the premium finance loan asset to a special purpose vehicle 250, which preferably includes transferring or selling the collateral assignment to the special purpose vehicle; issuing securities by the special purpose vehicle 255; selling the securities by the special purpose vehicle 260; imposing a fee to the insured for the premium finance loan 265; recouping any unpaid portion of the fees 270; arranging a policy loan 275; maintaining the one or more policy cash values 280; and obtaining policy cash surrender value loan for investor redemption 285.

The first step of the premium finance method 200 is obtaining short-term capital 215. The short-term capital 110 (as shown in FIG. 1) generally refers to the funds that are held for one year or less and are obtained through any sources of income, including without limitation, cash, credit employment, self-employment, business ventures, investments, shares, equities, loans, and/or any form of income, without deviating from the scope of the invention.

The second and third steps of the premium finance method 200, as shown in FIG. 2, are creating a prepaid structure 220 and creating a premium prepaid account 225. The prepaid structure 155 (as shown in FIG. 1) is typically a business plan, structure, or agreement that provides finance to an insurance policy of an insured 125, and utilizes a premium payment account 160, which is typically any bank account (e.g., checking, debit, or savings account) that is used solely to pay the premiums of the insurance policy on a regular basis. Preferably, the prepaid structure 155 does not subject the insurance policy to any adverse tax treatment, such as Section 7702A of the Internal Revenue Code (i.e., “Modified Endowment Contract(s)”), and should be approved by the insurance policy provider 120 involved with the insurance plan. Additionally, the payment model of the prepaid structure 155 is preferably a regular premium policy and not a single premium policy because a single premium policy might be subject to the Internal Revenue Code.

FIG. 2 shows the fourth step of the premium finance method 200—namely, paying or funding the initial payment of one or more premiums of the insurance policy 230. In particular, the premium finance company 105 (as shown in FIG. 1) typically pays for the initial premium of the insurance policy. This is preferably performed by using the funds obtained from the short-term capital 110 and may also be funds taken from the premium payment account 160.

FIG. 2 also shows the fifth step of the premium financing method 200 (i.e., funding the premium payment account 235), which is performed by the premium finance company (as shown in FIG. 1) 105. The premium finance company 105 uses funds derived from the premium payment account 160 to pay for the premiums of the life insurance policy. Specifically, the premium finance company 105 uses the funds to pay for the premium, subject to a discount, which is agreed between the insurance policy provider 120 and premium finance company 105. Typically, the discount is based upon the yield accrued from the premium payment account 160. The premium finance company 105 may then fund the premium payment account 160 with cash or capital on-hand, but may obtain such funds from different sources of income. The funds can be obtained through any sources of income, including without limitation, cash, employment, self-employment, business ventures, investments, shares, credits, or loans.

The sixth step of the premium financing method 200, as shown in FIG. 2, is creating a premium finance loan asset 240. By creating a prepaid structure 155, the premium financing company 105 may utilize the prepaid structure 155 as an asset, as is preferably done when the premium finance loan asset 115 is created. The premium finance loan asset 115 preferably has a predetermined minimum value, which can range from any dollar amount, and also has a maturity date, which is typically the final payment date of the prepaid structure 155. Additionally, the premium finance loan asset 115 would be subject to an underlying guaranty by the insurance policy provider 120. The guaranty is the agreement by which the insurance provider 120 assumes the responsibility of assuring payment of the prepaid structure 155.

FIG. 2 shows the seventh step of the premium financing method 200, which is obtaining a collateral assignment from the insured 245. The collateral assignment 140 is an asset assignment, in which the ownership rights of the premium finance loan asset 115, or other collateral, are transferred to the premium finance company 105 from the insured to secure the funding for the initial premium payment and funding for the premium payment account 160. Because the collateral assignment 140 functions only as an additional security for the loan, ownership of the premium finance loan asset 115 reverts back to the insured 125 once the loan is repaid. The collateral assignment 140 may also be used to guarantee the loan upon the death of insured 125, such that if the collateral assignment 140 is placed on a life insurance policy, the premium financing company 105 will receive any amount due to them before the beneficiary is paid. Thus, the collateral assignment 140 could be used in this manner to pay any unpaid amount due from the short-term capital and funds derived from the premium payment account 160. However, it should be understood that the present invention may include other agreed terms as well for the collateral assignment 140 without deviating from the scope of the invention.

The eighth step of the premium finance method 200, as shown in FIG. 2, is selling the premium finance loan asset to a special purpose vehicle 250. After the collateral assignment 140 has been made by the insured 125 to the premium financing company 105, the premium financing company 105 sells the premium finance loan asset 115 to the special purpose vehicle 145. Selling the premium finance loan asset 115 to the special purpose vehicle 145 typically requires transferring the collateral assignment 140, current and future cash value derived from the insurance policy, and interim balances of the premium payment account 160 to the special purpose vehicle 145. It should be understood, however, that the present invention allows the transferring of other assets as well to the special purpose vehicle 145.

FIG. 2 shows the ninth step of the premium financing method 200, which is issuing securities by the special purpose vehicle 255. Specifically, the special purpose vehicle 145, in using the premium finance loan asset 115 and collateral assignment 140, issues securities 150 or investment financial instruments. The securities 150 are preferably backed by guaranteed and non-guaranteed cash values of the life insurance policy, and may also be backed by the accrued interest payments of the premium finance loan until the premium finance loan matures.

Regarding the cash surrender value, it may have a guaranteed minimum value at a future point. The cash surrender value is guaranteed by the insurance carrier. If this is the case, there is a very low risk price discount. If the cash surrender value is not guaranteed, but there is a high probability of achieving based on historical insurance carrier dividend payouts and standard deviation, then there is merely a low risk price discount. If there is a carrier-approved split dollar arrangement, a percentage of the insured's death benefit is collateralized by and payable to the premium finance company 105 for reimbursement of any accrued financing charges, including expected yields for security investors.

The tenth step of the premium financing method 200, as shown in FIG. 2, is selling the securities by the special purpose vehicle 260. After issuing securities 150, the special interest vehicle 145 sells the securities 150 to replenish the short-term capital 110 of the premium finance loan. The short-term capital 110 may then be used to assist paying other prepaid structures 155 or fund any other financial arrangements and/or interests.

FIG. 2 shows the eleventh step of the premium financing method 200—i.e., imposing a fee to the insured for the premium finance loan 265. In particular, the premium financing company 105 charges a market-rate interest to the insured 125 for the premium finance loan. The interest may be a flat, fixed amortization of the interest payable until maturity of the premium finance loan. The present invention, however, permits the premium financing company to charge other fees as well.

The twelfth step of the premium financing method 200 is recouping any unpaid portion of the fee 270. Specifically, the premium financing company 105 may recoup any unpaid premium finance loan interest, which is preferably payable at maturity. The unpaid interest is preferably performed through a combination of policy cash value disbursements at maturity of the premium finance loan or split-dollar arrangements upon the policy death benefit proceeds, if appropriate. These arrangements, however, are typically disclosed and agreed upon by the insurance policy provider 120 at the onset of the prepaid structure 155.

FIG. 2 also shows the thirteenth step of the premium financing method 200, which is arranging a policy loan 275. The policy loan is a policy cash value disbursement, which is arranged at the maturity of the securities, and is used for the purpose of redeeming the security investment value.

Finally, FIG. 2 shows the fourteenth and fifteenth step of the premium financing method 200—i.e., maintaining the one or more policy cash values 280, and obtaining policy cash surrender value loan for investor redemption 285. Subsequent to the arrangement of the policy loan, sufficient cash value likely remains within the insurance policy. The cash value is generally used to assure the insurance policy remains in force through the minimum illustration period, and typically includes a reduced policy death benefit. Further, the fifteenth step addresses the event of redemption, which is the repurchasing of the securities or investments prior to maturity of the loan. When redemption occurs, the long-term investor 170 may obtain policy cash-value disbursements 130 funds from the issuer (i.e., special purpose vehicle 145).

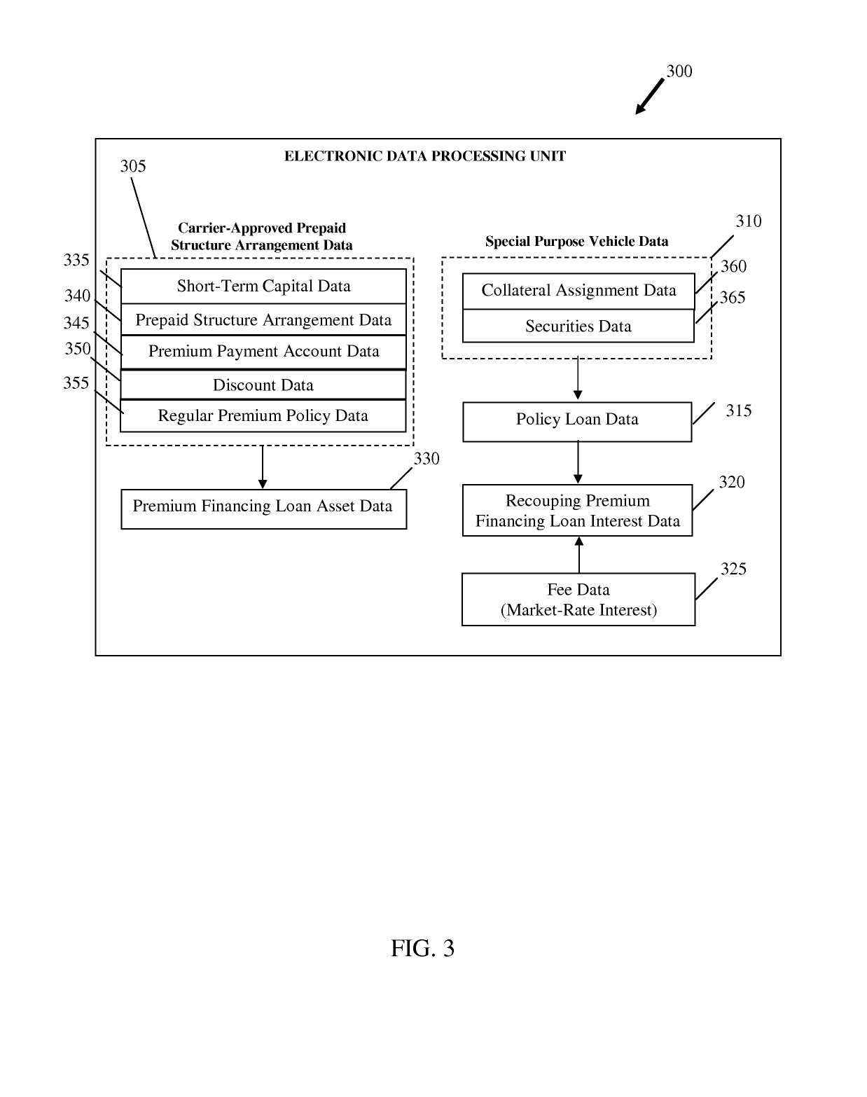

FIG. 3 is a block diagram of one embodiment of an electronic data processing unit of the computer-based method for premium financing and shows the data components of the computer-based method. As shown in FIG. 3, the electronic data processing unit 300 preferably includes: carrier-approved prepaid structure arrangement data 305; special purpose vehicle data 310; policy loan data 315; recouping premium financing loan interest data 320; fee data 325; and premium financing loan asset data 330. The carrier-approved prepaid structure arrangement data 305 preferably includes: short-term capital data 335; prepaid-structure arrangement data 340; premium payment account data 345; discount data 350; and regular premium policy data 355. As shown in FIG. 3, the special purpose vehicle data 310 preferably includes collateral assignment data 360 and securities data 365. Policy loan data 315 is typically information regarding the cash-value disbursement of the insurance policy. Specifically, the policy loan data 315 should include information as to the amount of cash surrender value and or cash value disbursements made over a period of time, the maturity loan information of the securities, policy loan investment value, death benefit information, and any other information, ensuring that the insurance policy remains in effect. Recouping premium financing loan interest data 320 is information of any unpaid premium finance loan interest that is payable at maturity. Such information typically includes calculations of both policy cash value disbursements at maturity of the loan and/or split-dollar arrangement on a policy death benefit proceeds. Fee data 325 is preferably information, which shows the amount of fees charged against the insured 125 and typically includes insurance loan interest information, which is preferably a flat, fixed amortization interest payable until maturity of the loan. Premium financing loan asset data 330 is information of the carrier-approved prepaid structure arrangement data, which provides combined calculations of the short-term capital data 335, prepaid structure arrangement data 340, premium payment account data 345, discount data 350, and regular premium policy data 355.

Regarding the carrier-approved prepaid structure arrangement data 305, FIG. 3 shows the short-term capital data 335, which is typically funding information that shows the amount of money derived from other sources of income and can include other information such as funds used for paying the initial payment of the insurance policy premium. The prepaid structure data 340 is preferably the information that provides the terms of the prepaid structure 155 such as the agreed amount of regular payments from the premium payment account 160, the loan's maturity date, and any other information relating to the prepaid structure 155. The premium payment account data 345 is information that provides the amount of funds in the premium payment account 160 and preferably includes information such as the amount of regular payments from the premium payment account 160, the balance of the premium payment account, the maturity date of the loan, bank account information, account yield information, and any other premium information. The discount data 350 is information that shows yield account information of the premium payment account 160 and may include other information such as the predetermined yield amount of the premium payment account 160 agreed between the premium finance company 105 and prepaid structure 155. The regular premium policy data 355 is information that illustrates the amount of regular payments towards premiums over a certain period of time, and may include other information as well such as the calculated maturity date and annual balances.

FIG. 3 also shows the special purpose vehicle data 310, which includes collateral assignment data 360 and securities data 365. The collateral assignment data 360 preferably includes information as to the terms of the assignment between the insured 125 and premium finance company 105, which typically includes information of the ownership rights of the premium finance loan asset premium finance loan, guarantees, and any balance amount due to the beneficiary and/or premium finance company. The securities data 365 generally provides information of the securities 150 issued by the special purpose vehicle 145 and typically includes information of the whole life investment products, registered/unregistered securities information, securities structure information, Comdex ratings information, cash surrender value information, payment information for insurance premiums, and minimum and maximum securities life value information.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description that shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A method for financing insurance policy premiums, the steps comprising:
obtaining a short-term capital;
creating a prepaid structure with one or more carriers to finance an insurance policy of an insured;
wherein said prepaid structure utilizes a premium finance loan;
wherein said prepaid structure utilizes a premium payment account;
wherein said premium payment account is used only to pay one or more premiums of said insurance policy;
funding an initial payment of said one or more premiums of said insurance policy with said short-term capital;
funding said premium payment account;
paying said one or more premiums of said insurance policy by using said premium payment account;
creating an asset;
wherein said asset is derived from said prepaid structure;
wherein said asset is subject to a guaranty by said one or more carriers;
selling said premium finance loan asset to a special purpose vehicle;
issuing one or more securities by said special purpose vehicle;
selling said one or more securities by said special purpose vehicle;

2. The method for financing insurance policy premiums of claim 1, further comprising the steps of:
obtaining a collateral assignment from said insured;
wherein said collateral assignment secures said funding of said initial payment of said one or more premiums;
wherein said collateral assignment secures said funding of said premium payment account; and
transferring said collateral assignment, one or more policy cash values, and one or more balances of said premium payment account to said special purpose vehicle.

3. The method for financing insurance policy premiums, of claim 2, wherein said one or more securities are sold to replenish said short-term capital.

4. The method for financing insurance policy premiums, of claim 2, further comprising the step of:
imposing a fee to said insured for said premium finance loan.

5. The method for financing insurance policy premiums, of claim 3, further comprising the steps of:
arranging a policy loan at a maturity of said one or more securities, such that a redemption of a security investment value exists; and
maintaining said one or more policy cash values, such that said policy loan remains in effect.

6. The method for financing insurance policy premiums of claim 5, wherein said prepaid structure does not subject said insurance policy to an adverse tax treatment and wherein said prepaid structure utilizes a regular premium policy.

7. The method of claim 6, wherein said one or more premiums are subject to one or more discounts;
wherein said one or more discounts are based upon a predetermined yield of said premium payment account;
wherein said asset has a predetermined minimum value; and
wherein said asset has a maturity date.

8. The method of claim 7, wherein said one or more securities is backed by said one or more policy cash values and one or more premium finance loan interest payments.

9. The method of claim 8, wherein said premium finance loan interest payments are payable until maturity of said premium finance loan.

10. The method of claim 9, wherein said fee is valued at a market-rate interest of said premium finance loan; and
wherein said market-rate interest is amortized until a maturity of said premium finance loan.

11. The method of claim 10, wherein said method further comprises the step of:
recouping an unpaid portion of said fee by obtaining one or more cash-value disbursements at maturity of said premium finance loan.

12. The method of claim 10, wherein said method further comprises the step of:
recouping an unpaid portion of said fee by obtaining one or more proceeds from a policy death benefit arrangement.

13. A computer-based method for storing and monitoring premium financing information, the steps comprising:
providing an electronic data processing unit;
inputting and storing a short-term capital data into said electronic data processing unit for an insurance policy;
wherein said short-term capital data provides an information regarding funding an initial payment of one or more premiums of said insurance policy of an insured;
creating a prepaid structure for said insurance policy;
inputting and storing a prepaid structure data of said prepaid structure into said electronic data processing unit;
wherein said prepaid structure data provides an information regarding said prepaid structure;
transferring funds to a premium payment account;
wherein said premium payment account is used for paying one or more premiums of said insurance policy;
inputting and storing a premium payment account data into said electronic data processing unit;
wherein said premium payment account data provides an information regarding funding said premium payment account;
creating a premium finance loan asset;
wherein said premium finance loan asset includes a predetermined minimum value in said electronic data processing unit;
determining a maturity date of said premium finance loan asset;
securing a collateral assignment from said insured;
inputting and storing a collateral assignment data into said electronic data processing unit;
wherein said collateral assignment data provides an information of said collateral assignment;
selling said premium finance loan asset to a special purpose vehicle;
inputting and storing premium finance loan asset data into said electronic data processing unit;
wherein said premium finance loan asset data provides an information regarding said premium finance loan asset;
transferring said collateral assignment and said premium payment account to said special purpose vehicle;
issuing one or more securities by said special purpose vehicle;
selling one or more securities by said special purpose vehicle;
inputting a securities data into said electronic data processing unit;
wherein said securities data provides an information regarding said one or more securities;
imposing a fee to said insured for said premium finance loan;
inputting and storing a fee data to said electronic data processing unit;
wherein said fee data provides an information regarding said fee;
arranging a policy loan at maturity of said one or more securities;
inputting and storing said policy loan data into said electronic data processing unit;
wherein said policy loan data provides an information regarding said policy loan;
maintaining said policy loan with a sufficient funding, such that said policy loan remains in effect; and
monitoring said policy loan data with said electronic data processing unit, such that said policy loan has sufficient funding.

14. The computer-based method for storing and monitoring premium financing information of claim 13, wherein said prepaid structure utilizes a regular premium policy;
inputting and storing a regular premium policy data into said electronic data processing unit; and
wherein said premium policy data provides an information regarding said regular premium policy.

15. The computer-based method for storing and monitoring premium financing information of claim 14, wherein said one or more premiums are subject to one or more discounts;
inputting and storing a discount data into said electronic data processing unit; and
wherein said discount data provides an information regarding one or more discounts.

16. The computer-based method for storing and monitoring premium financing information of claim 15, wherein said one or more securities are backed by one or more premium finance loan interest payments.

17. The computer-based method for storing and monitoring premium financing information of claim 16, wherein said fee is valued at a market-rate interest of said premium finance loan; and
wherein said market-rate interest is amortized until maturity of said premium finance loan.

18. The computer-based method for storing and monitoring premium financing information of claim 17, further comprising the steps of:
recouping an unpaid portion of said fee by obtaining one or more proceeds from a policy death benefit arrangement;
recouping an unpaid portion of said fee by obtaining one or more cash-value disbursements at said maturity of said premium finance loan;
inputting and storing one or more recouping data into said electronic data processing unit.

19. The computer-based method for storing and monitoring premium financing
information of claim 18, further comprising the steps of:
monitoring said short-term capital data;
monitoring said prepaid structure data;
monitoring said premium payment account data;
monitoring said collateral assignment data;
monitoring said premium finance loan asset data;
monitoring said securities data;
monitoring said fee data;
monitoring said policy loan data;
monitoring said regular premium policy data;
monitoring said discount data; and
monitoring said one or more recouping data;
wherein said monitoring steps are performed by using said electronic data processing unit.

20. A method for financing insurance policy premiums, the steps comprising:
obtaining a short-term capital;
creating a prepaid structure to finance an insurance policy of an insured;
wherein said prepaid structure utilizes a premium finance loan;
wherein said prepaid structure does not subject said insurance policy to an adverse tax treatment;
wherein said prepaid structure utilizes a premium payment account;
wherein said prepaid structure is approved by one or more insurance policy providers;
wherein said premium payment account is used solely for paying said one or more premiums of said insurance policy;
wherein said prepaid structure utilizes a regular premium policy;
funding said initial payment of one or more premiums of said insurance policy with said short-term capital;
funding said premium payment account, such that said one or more premiums of said insurance policy are always paid;
wherein said one or more premiums are subject to one or more discounts;
wherein said one or more discounts are based upon a predetermined yield of said premium payment account;
creating a premium finance loan asset;
wherein said premium finance loan asset is derived from said prepaid structure;
wherein said premium finance loan asset has a predetermined minimum value;
wherein said premium finance loan asset has a maturity date;
wherein said premium finance loan asset is subject to a guaranty by said one or more insurance policy providers;
obtaining a collateral assignment from said insured;
wherein said collateral assignment secures said funding of said initial payment of said one or more premiums;
wherein said collateral assignment secures said funding of said premium payment account;
selling said premium finance loan asset to a special purpose vehicle;
transferring said collateral assignment to said special purpose vehicle;
transferring one or more policy cash values to said special purpose vehicle;
transferring one or more balances of said premium payment account to said special purpose vehicle;
issuing one or more securities by said special purpose vehicle;
wherein said one or more securities is backed by said one or more policy cash values;
wherein said one or more securities is backed by one or more premium finance loan interest payments;
wherein said premium finance loan interest payments are payable until maturity of a premium finance loan;
selling said one or more securities by said special purpose vehicle to replenish said short-term capital;
imposing a fee to said insured for said premium finance loan;
wherein said fee is valued at a market-rate interest of said premium finance loan;
wherein said market-rate interest is amortized until maturity of said premium finance loan;
recouping an unpaid portion of said fee by obtaining one or more cash-value disbursements at said maturity of said premium finance loan;
recouping an unpaid portion of said fee by obtaining one or more proceeds from a policy death benefit arrangement;
arranging a policy loan at a maturity of said one or more securities, such that a redemption of a security investment value exists; and
maintaining said one or more policy cash values, such that said policy loan remains in effect.
